(19) United States
(12) Patent Application Publication
(10) Pub. No.: US 2016/0119259 A1
(43) Pub. Date: Apr. 28, 2016

(54) METHOD, TERMINAL DEVICE AND SERVER FOR PUSHING MESSAGE THROUGH LIGHT APPLICATION

(71) Applicant: Xiaomi Inc., Beijing (CN)

(72) Inventors: Yuanyang Li, Beijing (CN); Shuangxi Cao, Beijing (CN); Jinglong Zuo, Beijing (CN)

(21) Appl. No.: 14/580,230

(22) Filed: Dec. 23, 2014

Related U.S. Application Data
(63) Continuation of application No. PCT/CN2014/089302, filed on Oct. 23, 2014.

(51) Int. Cl. H04L 12/58

(52) U.S. Cl. CPC H04L 51/066; H04L 51/14

(57) ABSTRACT

The present disclosure relates to a method, a terminal device and a server for pushing message through light application, which belongs to the field of internet technology. The method comprises: acquiring an application list of light applications added to a terminal device, the application list listing at least one light application; sending the application list to a push server through a browser, so that the push server acquires a data packet to be pushed corresponding to the at least one light application according to the application list, the data packet to be pushed comprising at least a message to be pushed and push object information; and receiving the data packet to be pushed corresponding to the at least one light application through the browser.

### CROSS-REFERENCE TO RELATED APPLICATIONS

This application is a Continuation application of International Application No. PCT/CN2014/089302, filed on Oct. 23, 2014, which is based upon and claims priority to Chinese Patent Application No. CN201410347730.9, filed on Jul. 18, 2014, the entire contents of which are incorporated herein by reference.

### TECHNICAL FIELD

The present disclosure relates to the field of internet technology, and more particularly, to a method, a terminal device and a server for pushing a message through a light application.

### BACKGROUND

The applications available in application store, such as Apple's App Store and the Google Play marketplace are all “native” applications, in that developers built them using technology and code largely proprietary to those platforms. Recently, a Light application (or Light App) is developed by using a browser-supported programming language and relies on a web browser to render the application. Accordingly, the Light application, which is basically a way for other apps to run without actually downloading or installing them, has received wide attention because the light application occupies less memory, consumes less network traffic, and is easy to switch between different applications, etc.

A light application center embedded in a browser collects together most of the light applications that may be used in daily work and life. In the light application center, any kind of light applications may be added as desired, and each light application generally occupies hundreds of kilo bytes of memory. After a light application is added, an icon corresponding to the light application will be placed on the desktop of a terminal device. The light applications may realize about 90% of the functions provided by corresponding client applications, and may substantially satisfy all the user needs to the functions in normal conditions.

### SUMMARY

According to a first aspect of the embodiments of the present disclosure, there is provided a method for receiving a push message in a terminal device. The method includes: acquiring an application list of light applications added to a terminal device, the application list listing at least one light application; sending the application list to a push server through a browser, so that the push server acquires a data packet to be pushed corresponding to the at least one light application according to the application list, the data packet to be pushed including at least a message to be pushed and push object information; and receiving the data packet to be pushed corresponding to the at least one light application through the browser.

According to a second aspect of the embodiments of the present disclosure, there is provided a method for pushing a message in a server. The method comprises: receiving an application list listing at least one light application sent by a light application center through a browser, at least one light application being included in the application list; acquiring a message to be pushed corresponding to the at least one light application from messages to be pushed collected in advance according to the application list; generating a data packet to be pushed corresponding to the at least one light application, the data packet to be pushed including at least the message to be pushed and push object information; and sending the data packet to be pushed to the light application center, so that the light application center presents the message according to the data packet to be pushed.

According to a third aspect of the embodiments of the present disclosure, there is provided a terminal device. The terminal device comprises: a processor; and a memory for storing instructions executable by the processor; wherein the processor is configured to perform: acquiring an application list of light applications added to a terminal device, the application list listing at least one light application; sending the application list to a push server through a browser, so that the push server acquires a data packet to be pushed corresponding to the at least one light application according to the application list, the data packet to be pushed including at least a message to be pushed and push object information; and receiving the data packet to be pushed corresponding to the at least one light application through the browser.

According to a fourth aspect of the embodiments of the present disclosure, there is provided a server. The server comprises: a processor; and a memory for storing instructions executable by the processor; wherein the processor is configured to perform: receiving an application list listing at least one light application sent by a light application center through a browser, at least one light application being included in the application list; acquiring a message to be pushed corresponding to the at least one light application from messages to be pushed collected in advance according to the application list; generating a data packet to be pushed corresponding to the at least one light application, the data packet to be pushed including at least the message to be pushed and push object information; and sending the data packet to be pushed to the light application center, so that the light application center presents the message according to the data packet to be pushed.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for receiving a push message in a terminal device according to an exemplary embodiment.

FIG. 2 is a flow chart showing a method for pushing a message in a server according to an exemplary embodiment.

FIG. 3 is a flow chart showing a method for pushing a message according to an exemplary embodiment.

FIG. 4 is a schematic diagram showing a terminal device interface according to an exemplary embodiment.

FIG. 5 is a block diagram showing an apparatus for receiving a push message according to an exemplary embodiment.

FIG. 6 is a block diagram showing an apparatus for pushing a message according to an exemplary embodiment.

FIG. 7 is a block diagram showing a terminal device according to an exemplary embodiment.

FIG. 8 is a block diagram showing a server according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

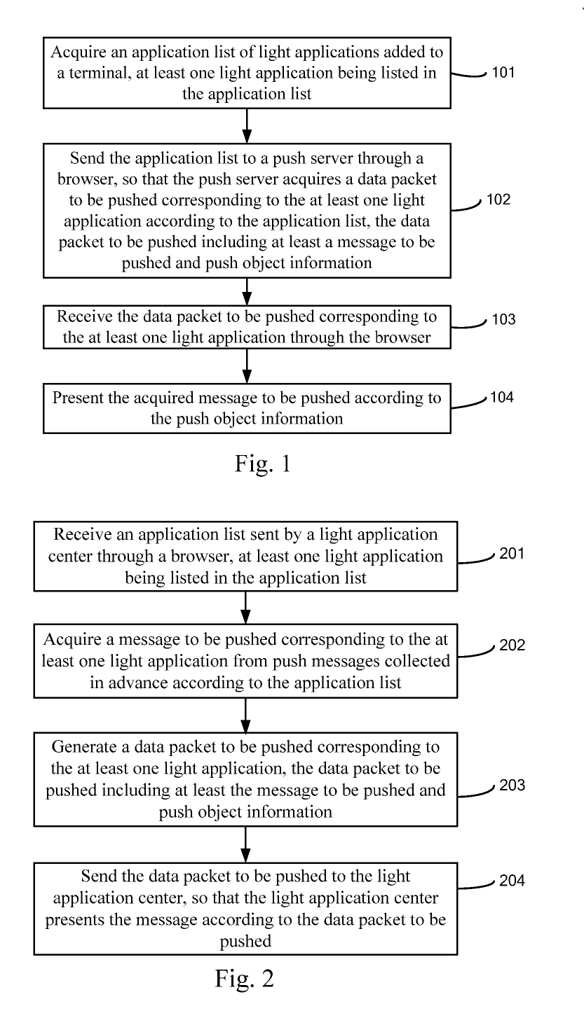

FIG. 1 is a flow chart showing a method for receiving a push message in a terminal device according to an exemplary embodiment. As shown in FIG. 1, the method for is performed in a terminal device, and includes the following steps.

In step 101, an application list of light applications added to a terminal device is acquired, wherein the application list lists at least one light application.

In step 102, the application list is sent to a push server through a browser, so that the push server acquires a data packet to be pushed corresponding to the at least one light application according to the application list, wherein the data packet to be pushed includes at least a message to be pushed and push object information.

In step 103, the data packet to be pushed corresponding to the at least one light application is received through the browser.

Optionally, the method may further include step 104. In step 104, the acquired message to be pushed is presented according to the push object information.

According to the method provided by the embodiments of the present disclosure, a light application center sends the application list to the push server through the browser after acquiring the application list of light applications added to the terminal device. The light application center receives the data packet to be pushed corresponding to at least one light application through the browser and presents the acquired message to be pushed according to the push object information, after the push server acquires the data packet to be pushed corresponding to at least one light application according to the application list. Since the light application realizes the message pushing function, the functional service of the light application can be extended, which improves the user experience and satisfies the functional needs of the light application publishers or the users.

Optionally, the step of presenting the acquired message to be pushed according to the push object information includes: determining a light application to be pushed corresponding to the message to be pushed according to the push object information; sending the message to be pushed to the light application to be pushed; displaying a push message prompt identification on an icon of the light application to be pushed; and opening the light application to be pushed to present the message to be pushed through the light application to be pushed when a click operation on the push message prompt identification is detected.

Optionally, the step of presenting the acquired message to be pushed according to the push object information includes: determining a light application to be pushed corresponding to the message to be pushed according to the push object information; sending the message to be pushed to the light application to be pushed; displaying push message prompt information in a system notification column; and opening the light application to be pushed to present the message to be pushed through the light application to be pushed when a click operation on the push message prompt information is detected.

All of the above alternative technical solutions may be combined in any form to form alternative embodiments of the present disclosure, which are not described repeatedly.

FIG. 2 is a flow chart showing a method for pushing a message in a server according to an exemplary embodiment. As shown in FIG. 2, the method is performed in a push server, and includes the following steps.

In step 201, an application list sent by a light application center through a browser is received, and at least one light application is listed in the application list.

In step 202, a message to be pushed corresponding to the at least one light application from messages to be pushed collected in advance according to the application list is acquired.

In step 203, a data packet to be pushed corresponding to the at least one light application is generated, the data packet to be pushed includes at least the message to be pushed and push object information.

In step 204, the data packet to be pushed is sent to the light application center, so that the light application center presents the message according to the data packet to be pushed.

According to the method provided by the embodiments of the present disclosure, a light application center sends the application list to the push server through the browser after acquiring the application list of light applications added to the terminal device. The light application center receives the data packet to be pushed corresponding to at least one light application through the browser and presents the acquired message to be pushed according to the push object information, after the push server acquires the data packet to be pushed corresponding to at least one light application according to the application list. Since the light application realizes the message pushing function, the functional service of the light application can be extended, which improves the user experience and satisfies the functional needs of the light application publishers or the users.

Optionally, before the acquiring the message to be pushed corresponding to the at least one light application from messages to be pushed collected in advance according to the application list, the method further includes: receiving messages to be pushed sent by a plurality of light application servers, and storing the received messages to be pushed.

Optionally, in another exemplary embodiment, before the acquiring the message to be pushed corresponding to the at least one light application from messages to be pushed collected in advance according to the application list, the method further may include: acquiring website updates over a preset period from the plurality of light application servers, and generating messages to be pushed corresponding to the plurality of light applications according to the website updates

All of the above alternative technical solutions may be combined in any form to form alternative embodiments of the present disclosure, which are not described repeatedly.

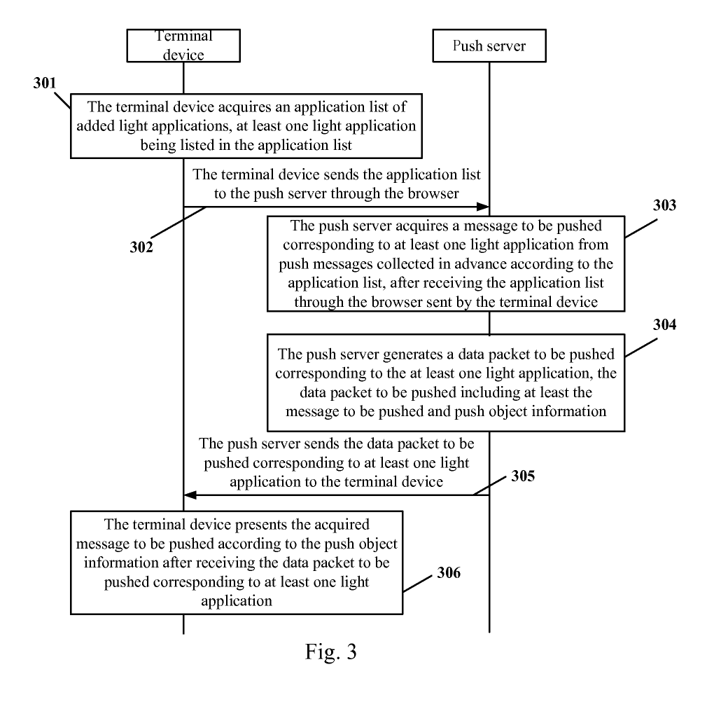

FIG. 3 is a flow chart showing a method for pushing a message according to an exemplary embodiment. The interaction subjects include a terminal device and a push server. At least one light application and a browser embedded with a light application center are installed in the terminal device. The light application center may collect together thousands of light applications, and the users may add various light applications to the light application center as desired. An icon of the light application will be placed on the desktop after the light application is added. As shown in FIG. 3, the method mainly includes the following steps.

In step 301, a terminal device acquires an application list of light applications added to the terminal device, wherein at least one light application is listed in the application list.

In the embodiments of the present disclosure, the terminal device acquires the application list of the added light applications through the light application center. The light application center may provide support for various light applications provided by each application server. Moreover, the light application center also determines how the browser displays the content of a web page and format information of the page. In other words, the light application center further includes a browser core through which the light application presents the content of the web page in a manner similar to the client applications.

For example, in a news application in form of client application, a news application server usually captures news content from We Media platform such as a news website or a micro blog, and presents the captured news content on the news application in form of client application. The difference is that, the news application in form of client application needs to be installed using a relatively large installation package of megabytes or even tens of megabytes, but the light application does not need to be installed using such a package. The light application generally needs to be installed simply using a shell, and the installation package of the light application is usually of a size of a few hundred kilo bytes. In other words, using the light application is essentially browsing the web page, while the light application is presented in a manner similar to the client application.

Furthermore, after a light application is added by a user, the light application center will record it, and form a light application list of light applications added to the terminal device. In other words, the light application added to the terminal device can be managed by the light application center. Thus, the terminal device may directly pull out the light application list from the light application center. At least one light application may be listed in the application list.

In step 302, the terminal device sends the application list to the push server through the browser.

When the terminal device sends the application list to the push server through the browser, the application list may be packed and then sent through the browser, or the application list may be sent through the browser directly, the specific way of sending the application list is not limited by the embodiments of the present disclosure.

In step 303, the push server acquires a message to be pushed corresponding to at least one light application from messages to be pushed collected in advance according to the application list, after the application list through the browser sent by the terminal device is received.

In the embodiments of the present disclosure, the messages to be pushed collected in advance by the push server may be obtained in the following two ways.

As a first way, messages to be pushed sent by a plurality of light application servers are received, and the received messages to be pushed are stored.

In the first way, a plurality of light application servers actively send messages to be pushed to the push server. For a light application server such as a news light application, when the light application server captures fresh news message from a We Media platform such as a news website or a micro blog, etc., the light application server actively sends the news message as the message to be pushed to the push server. The push server may temporarily store the news message after receiving the news message. The storage medium may be a flash memory, a hard disk, etc., and the type of the storage medium is not particularly limited by the embodiments of the present disclosure.

It should be noted that, when the push server temporarily stores the push message, it allots a piece of storage space for each light application in the light application center. Thus, the messages to be pushed corresponding to a light application will be stored in the same piece of storage space, and a push message of a light application A may not be confused with a push message of a light application B during a message pushing process.

As a second way, website updates over a preset period are acquired from a plurality of light application servers, and messages to be pushed corresponding to a plurality of light applications are generated according to the website updates.

In the second way, the push server actively acquires messages to be pushed from the plurality of light application servers. The push server may acquire latest updates from the plurality of light application servers at a preset period according to a capture algorithm, and directly store the acquired latest updates as messages to be pushed, or conduct a process such as combination or deletion to the acquired the latest updates to generate message to be pushed and store them. The preset period may be 5 minutes or 10 minutes, etc. which is not particularly limited in the present disclosure.

No matter in which manner the messages to be pushed of the plurality of light applications are collected, the messages to be pushed may be stored by the push server in the storing manner as shown in Table 1.

TABLE 1

| light application | message to be pushed |
|---|---|
| Light application 1 | message to be pushed 1 |
| | . . . |
| | message to be pushed N |
| . . . | . . . |
| Light application N | message to be pushed 1 |
| | . . . |
| | message to be pushed N |

In the embodiments of the present disclosure, after the messages to be pushed of the plurality of light applications are collected in advance, when the application list sent by the terminal device through the browser is received, the push server acquires a message to be pushed corresponding to each light application in the application list from the messages to be pushed of the plurality of light applications collected in advance according to the storage relationship in the application list and as shown in Table 1.

However, in addition to the above way of acquiring the message to be pushed of each light application in the application list, other acquiring ways are also applicable, which are not particularly limited in the embodiments of the present disclosure.

In step 304, the push server generates a data packet to be pushed corresponding to the at least one light application. The data packet to be pushed includes at least the message to be pushed and push object information.

In the embodiments of the present disclosure, the push server will also generate the data packet to be pushed corresponding to each light application after acquiring the message to be pushed corresponding to each light application. In addition to the message to be pushed, the data packet to be pushed also includes the push object information. The push object information may clearly indicate which light application the message to be pushed will be pushed to. The push object information may be an application identification of the light application, for instance, an application name or an application icon of the light application, etc. The manner of representing the push object information is not particularly limited in the embodiments of the present disclosure.

However, in addition to the message to be pushed and the push object information, the data packet to be pushed may also include other information, for instance, generation time of the messages to be pushed, the number of the messages to be pushed, etc., The content included in the data packet to be pushed are not particularly limited in the embodiments of the present disclosure.

In step 305, the push server sends the data packet to be pushed corresponding to at least one light application to the terminal device.

In the embodiments of the present disclosure, when sending the data packet to be pushed corresponding to at least one light application in the application list, the push server sends the data packet to be pushed corresponding to at least one light application to the browser installed on the terminal device. Furthermore, since the data packet to be pushed may include pictures or a plurality of push items, the data packet may be relatively large. In order to facilitate the transmission of the data packet to be pushed, the data packet to be pushed may be packed and then sent to the browser of the terminal device. However, the data packet to be pushed may be directly sent out. The way of sending is not particularly limited in the embodiments of the present disclosure.

In step 306, the terminal device presents the acquired message to be pushed according to the push object information after the data packet to be pushed corresponding to at least one light application is received.

In the embodiments of the present disclosure, after receiving the data packet to be pushed corresponding to at least one light application through the browser, the terminal device does not need to know the specific content of the data packet to be pushed, but it directly forwards the data packet to be pushed to the light application center. The light application center may present the message to be pushed in the following two ways after the data packet to be pushed is received and parsed, thereby pushing the message to the user through a light application.

As a first way, for each data packet to be pushed, a light application to be pushed corresponding to the message to be pushed is determined according to the push object information. Then the message to be pushed is sent to the light application to be pushed. After that, a push message prompt identification is displayed on an icon of the light application to be pushed. Then the light application to be pushed is opened to present the message to be pushed through the light application to be pushed when a click operation on the push message prompt identification is detected.

In the first way, the light application center of the terminal device processes each data packet to be pushed according to the above described way after the plurality of data packets to be pushed is received. Since each data packet to be pushed includes the push object information that may uniquely identify a light application, the light application to be pushed corresponding to the message to be pushed in the data packet to be pushed may be determined in the application list of the light applications added to the terminal device according to the push object information in the data packet to be pushed.

After the light application to be pushed is determined, the light application center sends the message to be pushed to the light application to be pushed. Furthermore, the push message prompt identification is placed on an icon of the light application to be pushed to prompt the user. The push message prompt identification may be placed on the upper right or the lower right or other region of the icon, which is not particularly limited in the embodiments of the present disclosure. The push message prompt identification may be specifically a string of characters, such as an English word “NEW” or a Chinese word “New”, which is also not particularly limited in the embodiments of the present disclosure.

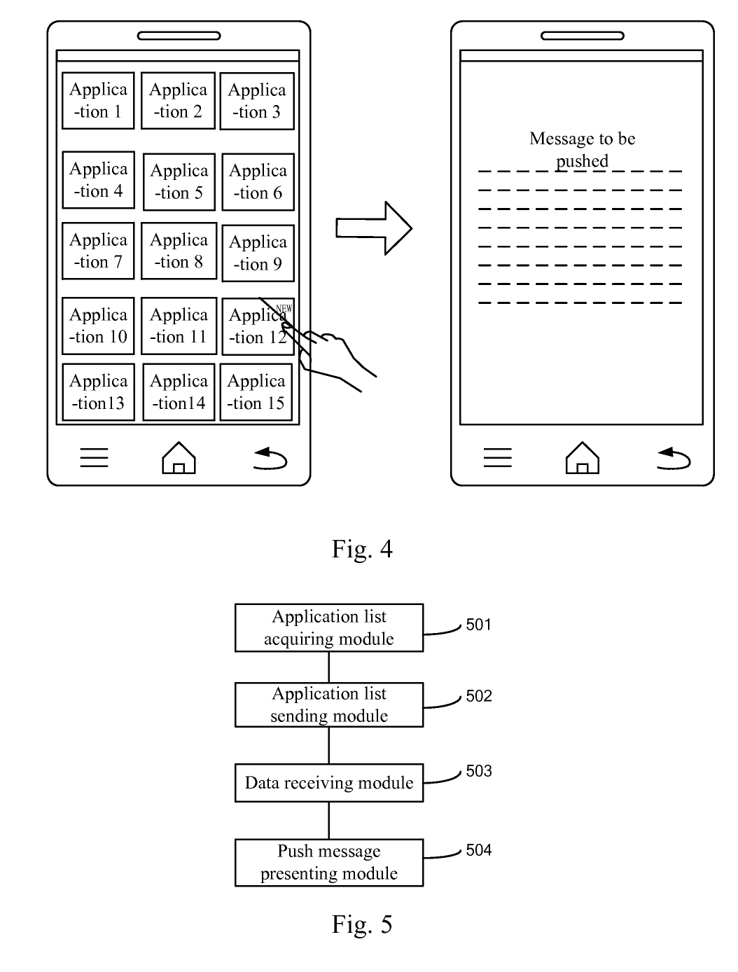

Furthermore, referring to FIG. 4, when a click operation on the push message prompt identification is detected, i.e., when a click operation on the icon of the light application to be pushed is detected, the light application to be pushed is opened. Then the process directly jumps to a relevant page of the opened light application. The message to be pushed is presented in the relevant page. Since each light application is placed on the desktop in a specific position, it may be determined that the icon of the light application is clicked when a click operation at the position of the light application is detected.

As a second way, for each data packet to be pushed, a light application to be pushed corresponding to the message to be pushed is determined according to the push object information. Then the message to be pushed is sent to the light application to be pushed. Push message prompt information is placed in a system notification column. Then the light application to be pushed is opened to present the message to be pushed through the light application to be pushed when a click operation on the push message prompt information is detected.

In the second way, the light application center of the terminal device processes each data packet to be pushed according to the above described way after the plurality of data packets to be pushed are received. Since each data packet to be pushed includes the push object information that may uniquely identify one light application, the light application to be pushed corresponding to the message to be pushed in the data packet to be pushed may be determined in the application list of the light applications added to the terminal device according to the push object information in the data packet to be pushed.

The light application center sends the message to be pushed to the light application to be pushed after the light application to be pushed is determined. Moreover, the push message prompt information is displayed on the system notification column of the terminal device to prompt the user. The push message prompt information may be a part of the message to be pushed such as an initial part of the message to be pushed. The push message prompt information may alternatively be a text “**light application has received a push message”. The form of the push message prompt information is not particularly limited in the embodiments of the present disclosure.

When a click operation on the push message prompt information is detected, the light application to be pushed is opened, and the process directly jumps to a relevant page of the light application. The message to be pushed is presented in the relevant page.

According to the method provided by the embodiments of the present disclosure, the light application center sends the application list to the push server through the browser after acquiring the application list of a light application added to the terminal device. The light application center receives the data packet to be pushed corresponding to at least one light application through the browser and presents the acquired message to be pushed according to the push object information, after the push server acquires the data packet to be pushed corresponding to at least one light application according to the application list. Since the light application realizes the message pushing function, the functional service of the light application can be extended, which improves the user experience and satisfies the functional needs of the light application publishers or the users.

FIG. 5 is a block diagram showing an apparatus for receiving a push message through a light application according to an exemplary embodiment. Referring to FIG. 5, the apparatus includes an application list acquiring module 501, an application list sending module 502, and a data receiving module 503. Optionally, the apparatus may include a push message presenting module 504.

The application list acquiring module 501 is configured to acquire an application list of light applications added to a terminal device, wherein at least one light application is listed in the application list. The application list sending module 502 is configured to send the application list to a push server through a browser, so that the push server acquires a data packet to be pushed corresponding to the at least one light application according to the application list, wherein the data packet to be pushed includes at least a message to be pushed and push object information. The data receiving module 503 is configured to receive the data packet to be pushed corresponding to the at least one light application through the browser. The push message presenting module 504 is configured to present the acquired message to be pushed according to the push object information.

Optionally, the push message presenting module is configured to determine a light application to be pushed corresponding to the message to be pushed according to the push object information; send the message to be pushed to the light application to be pushed; display a push message prompt identification on an icon of the light application to be pushed; and open the light application to be pushed to present the message to be pushed through the light application to be pushed when a click operation on the push message prompt identification is detected.

Optionally, the push message presenting module is configured to determine a light application to be pushed corresponding to the message to be pushed according to the push object information; send the message to be pushed to the light application to be pushed; display push message prompt information in a system notification column; and open the light application to be pushed to present the message to be pushed through the light application to be pushed when a click operation on the push message prompt information is detected.

According to the device provided by the embodiments of the present disclosure, a light application center sends the application list to the push server through the browser after acquiring the application list of a light application added to the terminal device. The light application center receives the data packet to be pushed corresponding to at least one light application through the browser and presents the acquired message to be pushed according to the push object information, after the push server acquires the data packet to be pushed corresponding to at least one light application according to the application list. Since the light application realizes the message pushing function, the functional service of the light application can be extended, which improves the user experience and satisfies the functional needs of the light application publishers or the users.

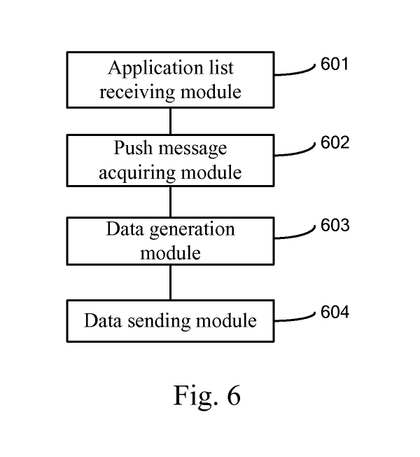

FIG. 6 is a block diagram showing an apparatus for pushing a message through a light application according to an exemplary embodiment. Referring to FIG. 6, the apparatus includes an application list receiving module 601, a push message acquiring module 602, a data generation module 603, and a data sending module 604.

The application list receiving module 601 is configured to receive an application list sent by a light application center through a browser, wherein at least one light application is listed in the application list. The push message acquiring module 602 is configured to acquire a message to be pushed corresponding to the at least one light application from messages to be pushed collected in advance according to the application list. The data generation module 603 is configured to generate a data packet to be pushed corresponding to the at least one light application, wherein the data packet to be pushed includes at least the message to be pushed and push object information. The data sending module 604 is configured to send the data packet to be pushed to the light application center, so that the light application center presents the message according to the data packet to be pushed.

Optionally, the apparatus further includes: a push message collection module configured to receive the message to be pushed sent by a plurality of light application servers, and store the received message to be pushed; or acquire website updates over a preset period from the plurality of light application servers, and generate the message to be pushed corresponding to the plurality of light applications according to the website updates.

According to the apparatus provided by the embodiments of the present disclosure, the light application center sends the application list to the push server through the browser after acquiring the application list of a light application added to the terminal device. The light application center receives the data packet to be pushed corresponding to at least one light application through the browser and presents the acquired message to be pushed according to the push object information, after the push server acquires the data packet to be pushed corresponding to at least one light application according to the application list. Since the light application realizes the message pushing function, the functional service of the light application can be extended, which improves the user experience and satisfies the functional needs of the light application publishers or the users.

With respect to the device in the above embodiments, specific operations performed by each module have been described in detail in the embodiments of related method, and detailed description will not be repeated here.

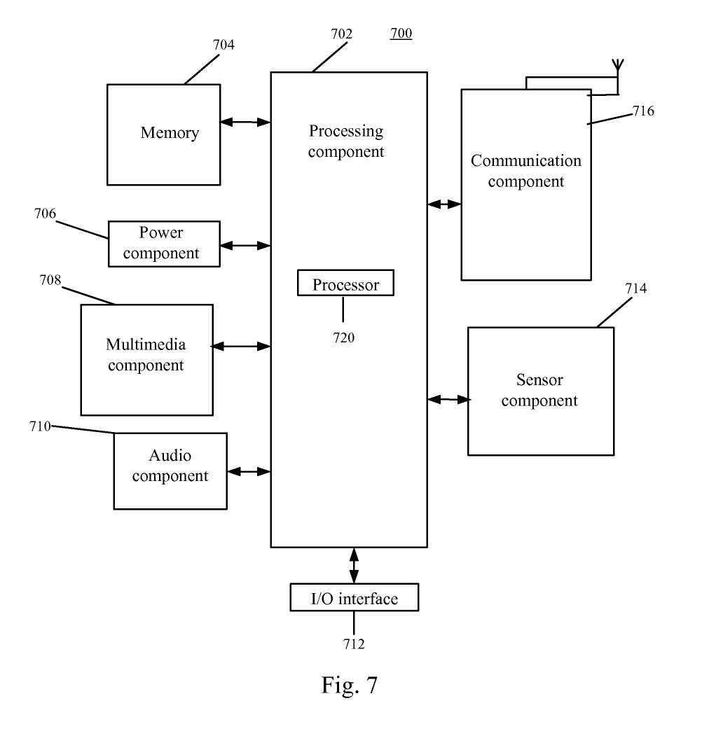

FIG. 7 is a block diagram showing a terminal device 700 for message push of the light application according to an exemplary embodiment. For instance, the terminal device 700 may be a mobile phone, a computer, a digital broadcast terminal device, a messaging device, a gaming console, a tablet, a medical device, an exercise equipment, a personal digital assistant and the like.

Referring to FIG. 7, the terminal device 700 may include one or more of the following components: a processing component 702, a memory 704, a power component 706, a multimedia component 708, an audio component 710, an I/O (Input/Output) interface 712, a sensor component 714, and a communication component 716.

The processing component 702 usually controls an overall operation of the terminal device 700 such as the operations associated with display, telephone calls, data communications, camera operations, and recording operations. The processing component 702 may include one or more processors 720 to execute instructions to perform all or part of the steps in the above described methods. Furthermore, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the terminal device 700. Examples of such data include instructions for any application or method operated on the terminal device 700, contact data, phonebook data, messages, pictures, videos, etc. The memory 704 may be implemented using any type of volatile or non-volatile memory device or combination thereof, e.g. a SRAM (Static Random Access Memory), an EEPROM (Electrically Erasable Programmable Read-Only Memory), an EPROM (Erasable Programmable Read-Only Memory), a PROM (Programmable Read-Only Memory), a ROM (Read-Only Memory), a magnetic memory, a flash memory, a magnetic or optical disk.

The power component 706 provides power to various components of the terminal device 700. The power component 706 may include a power management system, one or more power sources, and other components associated with the generation, management, and distribution of power in the terminal device 700.

The multimedia component 708 includes a screen providing an output interface between the terminal device 700 and the user. In some embodiments, the screen may include a Liquid Crystal Display (LCD) and a Touch Panel (TP). If the screen includes the TP, the screen may be implemented as a touch screen to receive input signals from the user. The TP includes one or more touch sensors to sense touches, slides, and gestures on the touch panel. The touch sensors may not only sense a boundary of a touch or slide action, but also sense a duration and pressure associated with the touch or slide action. In some embodiments, the multimedia component 708 includes a front camera and/or a rear camera. The front camera and/or the rear camera may receive an external multimedia datum while the terminal device 700 is in an operation mode such as a photographing mode or a video mode. Each of the front camera and the rear camera may be a fixed optical lens system or have optical zooming capability.

The audio component 710 is configured to output and/or input audio signals. For instance, the audio component 710 includes a microphone (MIC) configured to receive an external audio signal when the terminal device 700 is in an operation mode such as a call mode, a recording mode, and a voice identification mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules such as a keyboard, a click wheel, a button, and the like. The button may include, but be not limited to, a home button, a volume button, a starting button, and a lock button.

The sensor component 714 includes one or more sensors to assess the status of various aspects of the terminal device 700. For instance, the sensor component 714 may detect an on/off status of the terminal device 700, relative positioning of components such as the display and the keyboard of the terminal device 700, a change in position of the terminal device 700 or a component of the terminal device 700, presence or absence of user contact with the terminal device 700, orientation or acceleration/deceleration of the terminal device 700, and a change in temperature of the terminal device 700. The sensor component 714 may include a proximity sensor configured to detect the presence of nearby objects without any physical contact. The sensor component 714 may also include a light sensor, such as a CMOS (Complementary Metal Oxide Semiconductor) or CCD (Charge-coupled Device) image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, either wired or wirelessly, between the terminal device 700 and other devices. The terminal device 700 can access a wireless network based on a communication standard such as WiFi, 2G or 3G, or a combination thereof. In one exemplary embodiment, the communication component 716 receives a broadcast signal or broadcast associated information from an external broadcast management system via a broadcast channel. In one exemplary embodiment, the communication component 716 further includes a NFC (Near Field Communication) module to facilitate short-range communications. For instance, the NFC module may be implemented based on a RFID (Radio Frequency Identification) technology, an IrDA (Infra-red Data Association) technology, an UWB (Ultra Wideband) technology, a BT (Bluetooth) technology, and other technologies.

In exemplary embodiments, the terminal device 700 may be implemented with one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), controllers, micro-controllers, microprocessors, or other electronic components, for performing the above described method.

In exemplary embodiments, there is also provided a non-transitory computer readable storage medium including instructions such as the memory 704 including instructions executable by the processor 720 in the terminal device 700, to perform the above described method. For instance, the non-transitory computer-readable storage medium may be a ROM, a RAM (Random Access Memory), a CD-ROM (Compact Disc Read-Only Memory), a magnetic tape, a floppy disc, an optical data storage device, and the like.

A non-transitory computer readable storage medium, when instructions in the storage medium are executed by a processor of a terminal device, the terminal device can execute a method for pushing a message through a light application, the method includes: acquiring an application list of light applications added to a terminal device, the application list listing at least one light application; sending the application list to a push server through a browser, so that the push server acquires a data packet to be pushed corresponding to the at least one light application according to the application list, the data packet to be pushed including at least a message to be pushed and push object information; and receiving the data packet to be pushed corresponding to the at least one light application through the browser.

According to the non-transitory computer readable storage medium provided by the embodiments of the present disclosure, a light application center sends the application list to the push server through the browser after acquiring the application list of a light application added to the terminal device. The light application center receives the data packet to be pushed corresponding to at least one light application through the browser and presents the acquired message to be pushed according to the push object information, after the push server acquires the data packet to be pushed corresponding to at least one light application according to the application list. Since the light application realizes the message pushing function, the functional service of the light application can be extended, which improves the user experience and satisfies the functional needs of the light application publishers or the users.

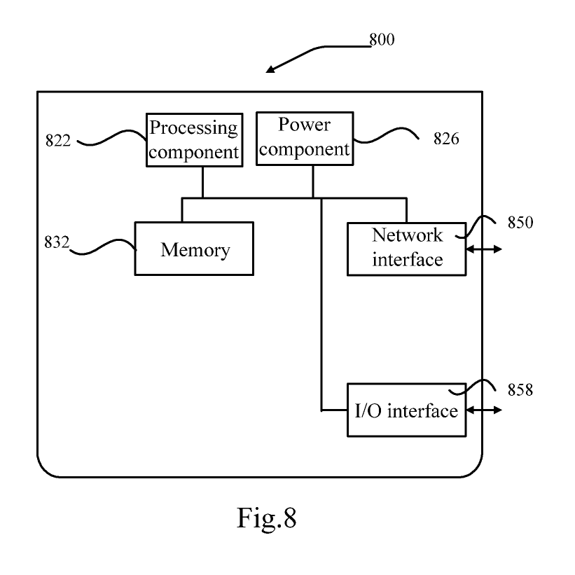

FIG. 8 is a block diagram showing a server 800 for message push of the light application according to an exemplary embodiment. Referring to FIG. 8, the server 800 includes a processing component 822 that further includes one or more processors, and memory resources represented by a memory 832 for storing instructions such as application programs executable by the processing component 822. The application programs stored in the memory 832 may include one or more modules, each of which corresponds to a set of instructions. Moreover, the processing component 822 is configured to execute the instructions to perform the method for pushing message for the light application executed by the server in the embodiment of the above described method.

The server 800 may also include a power component 826 configured to perform power management of the server 800, wired or wireless network interface(s) 850 configured to connect the server 800 to a network, and an input/output (I/O) interface 858. The server 800 may operate based on an operating system stored in the memory 832, such as Windows Server™, Mac OS X™, Unix™, Linux™, FreeBSD™, or the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for receiving a push message, comprising:
acquiring an application list of light applications added to a terminal device, the application list listing at least one light application;
sending the application list to a push server through a browser, so that the push server acquires a data packet to be pushed corresponding to the at least one light application according to the application list, the data packet to be pushed comprising at least a message to be pushed and push object information; and
receiving the data packet to be pushed corresponding to the at least one light application through the browser.

2. The method according to claim 1, wherein the method further comprises: presenting the acquired message to be pushed according to the push object information.

3. The method according to claim 2, wherein presenting the acquired message to be pushed according to the push object information comprises:
determining a light application to be pushed corresponding to the message to be pushed according to the push object information;
sending the message to be pushed to the light application to be pushed;
displaying a push message prompt identification on an icon of the light application to be pushed; and
opening the light application to be pushed to present the message to be pushed through the light application to be pushed, when a click operation on the push message prompt identification is detected.

4. The method according to claim 1, wherein presenting the acquired message to be pushed according to the push object information comprises:
determining a light application to be pushed corresponding to the message to be pushed according to the push object information;
sending the message to be pushed to the light application to be pushed;
displaying push message prompt information in a system notification column; and
opening the light application to be pushed to present the message to be pushed through the light application to be pushed, when a click operation on the push message prompt information is detected.

5. The method according to claim 1, wherein the method further comprises:
receiving an application list listing at least one light application sent by a light application center through a browser;
acquiring a message to be pushed corresponding to the at least one light application from messages to be pushed collected in advance, according to the application list;
generating a data packet to be pushed corresponding to the at least one light application, the data packet to be pushed including at least the message to be pushed and push object information; and
sending the data packet to be pushed to the light application center, so that the light application center presents the message according to the data packet to be pushed.

6. The method according to claim 5, wherein before acquiring the message to be pushed corresponding to the at least one light application from the messages to be pushed collected in advance according to the application list, the method further comprises:
receiving messages to be pushed sent by a plurality of light application servers, and storing the received messages to be pushed.

7. The method according to claim 5, wherein before acquiring the message to be pushed corresponding to the at least one light application from the messages to be pushed collected in advance according to the application list, the method further comprises:
acquiring website updates over a preset period from the plurality of light application servers, and generating messages to be pushed corresponding to a plurality of light applications according to the website updates.

8. A terminal device, comprising:
a processor; and
a memory for storing instructions executable by the processor;
wherein the processor is configured to perform:
acquiring an application list of light applications added to a terminal device, the application list listing at least one light application;
sending the application list to a push server through a browser, so that the push server acquires a data packet to be pushed corresponding to the at least one light application according to the application list, the data packet to be pushed comprising at least a message to be pushed and push object information; and
receiving the data packet to be pushed corresponding to the at least one light application through the browser.

9. The terminal device according to claim 8, wherein the processor is further configured to perform: presenting the acquired message to be pushed according to the push object information.

10. The terminal device according to claim 8, wherein presenting the acquired message to be pushed according to the push object information comprises:
determining a light application to be pushed corresponding to the message to be pushed according to the push object information;
sending the message to be pushed to the light application to be pushed;
displaying a push message prompt identification on an icon of the light application to be pushed; and
opening the light application to be pushed to present the message to be pushed through the light application to be pushed, when a click operation on the push message prompt identification is detected.

11. The terminal device according to claim 8, wherein presenting the acquired message to be pushed according to the push object information comprises:
determining a light application to be pushed corresponding to the message to be pushed according to the push object information;
sending the message to be pushed to the light application to be pushed;
displaying push message prompt information in a system notification column; and
opening the light application to be pushed to present the message to be pushed through the light application to be pushed, when a click operation on the push message prompt information is detected.

12. A server, comprising:
a processor; and
a memory for storing instructions executable by the processor;
wherein the processor is configured to perform:
receiving an application list listing at least one light application sent by a light application center through a browse;
acquiring a message to be pushed corresponding to the at least one light application from messages to be pushed collected in advance, according to the application list;
generating a data packet to be pushed corresponding to the at least one light application, the data packet to be pushed including at least the message to be pushed and push object information; and
sending the data packet to be pushed to the light application center, so that the light application center presents the message according to the data packet to be pushed.

13. The server according to claim 12, wherein, before acquiring the message to be pushed corresponding to the at least one light application from the messages to be pushed collected in advance according to the application list, the processor is further configured to perform:
receiving messages to be pushed sent by a plurality of light application servers, and storing the received messages to be pushed.

14. The server according to claim 12, wherein, before acquiring the message to be pushed corresponding to the at least one light application from the messages to be pushed collected in advance according to the application list, the processor is further configured to perform:
acquiring website updates over a preset period from the plurality of light application servers, and generating messages to be pushed corresponding to a plurality of light applications according to the website updates.
